(19) United States
(12) Patent Application Publication
(10) Pub. No.: US 2004/0012466 A1
(43) Pub. Date: Jan. 22, 2004

(54) Cavity resonator and microwave filter comprising auxiliary screen(s) for temperature compensation

(76) Inventors: Wolfgang Hauth, Backnang (DE); Dietmar Schmitt, Allmersbach I.T. (DE)

Correspondence Address: KENYON & KENYON, ONE BROADWAY, NEW YORK, NY, 10004, US

(21) Appl. No.: 10/362,814

(22) PCT Filed: May 26, 2001
(86) PCT No.: PCT/DE01/02033

(30) Foreign Application Priority Data
Aug. 26, 2000 (DE) 100 42 009.5

(51) Int. Cl. H01P 1/20; H01P 7/06

(52) U.S. Cl. 333/202; 333/230

(57) ABSTRACT

A cavity resonator having a coupling iris (3) has an auxiliary iris (5) which divides the resonator (1) into a coupling space (8) and a resonator space (9). Thus, the auxiliary iris (5) alters the length effective for the resonant frequency of the resonator (1). Disturbances, particularly temperature-induced deformations of the coupling iris (3), may thereby be effectively compensated.

### BACKGROUND INFORMATION

The present invention is based on a microwave resonator having a coupling iris for coupling to a further microwave resonator or to a waveguide.

Microwave resonators are coupled to each other via irises for implementing microwave filters. Such a microwave filter is known from the U.S. Pat. No. 5,867,077. There, the end faces for coupling energy in and out, as well as the irises for the bridging, i.e. the irises which couple the microwave resonators to one another, in each case extend into the resonant cavity of one of the microwave resonators. The end faces as well as the bridging irises themselves are made of a material which has a more positive temperature coefficient than the material of the lateral surfaces of the resonators. The expansion of the lateral surfaces in response to an increase in temperature can be compensated by the contrary change of the end faces and bridging irises. This contributes to the stability of the resonant frequency of the microwave filter, even in the event of temperature changes.

### SUMMARY OF THE INVENTION

The measures in claim 1 make it possible to use relatively thin iris structures between microwave resonators for implementing microwave filters, or for the coupling of a microwave filter to a waveguide, without deformations of the irises and/or field distortions, particularly in response to temperature change, in the axial direction of the resonator having an unfavorable effect on the resonant frequency of the resonator or the adjoining resonators. Due to the measure of the invention, the influence of the iris form on the adjoining modes cannot have a disadvantageous effect, since the frequency-determining resonator space of the microwave resonator does not extend up to the respective coupling iris, but rather only up to the auxiliary iris, provided according to the present invention, which divides the microwave resonator into a frequency-determining resonator space and a coupling space which is not frequency-determining.

Compared to the implementation according to U.S. Pat. No. 5,867,077, the effects of temperature can be compensated more easily than by a deliberately contrary temperature characteristic of different materials. Thus, by varying the distance between the auxiliary iris and the coupling iris, it is possible to achieve the compensation more easily and simply than by deliberately contrary materials. A further advantage is that the compensation may be set or reset by shifting the auxiliary iris after putting the resonator into operation, if desired.

The present invention is based on the following findings:

Microwave filters are usually constructed with the aid of coupling structures between resonators. In so doing, it is advantageous to use relatively thin irises which are provided with apertures, and consequently establish the energy-coupling ratio between the resonators. The operating modes upstream and downstream of the iris structure end at the surface of the shared coupling iris and experience a field distortion through the iris aperture which is more often than not small relative to the iris size. Therefore, the iris acts simultaneously on both adjoining resonators. If both resonators are equal, the effect of the iris on both modes is also equal. The form of the iris, together with the field-strength distribution, determines the type of coupling. It may be electrical, magnetic or both. A filter function is first able to be implemented by this coupling effect. In addition, the frequency-dependent, complex impedance and also the ohmic losses of the iris may load the adjacent resonators. Different iris forms can have equal coupling effects, with different loading of the adjacent resonators.

However, in many applications, the demand is that the influence of the iris form on the adjacent modes be as negligible as possible. Deformations of the irises in the axial direction would affect the resonant frequencies of the adjacent resonators differently, which is effectively prevented by the measures of the present invention.

It may be that it is known from the U.S. Pat. No. 6,005,457 to introduce auxiliary irises in resonant cavities of coupled resonators to form a microwave filter 5. However, these auxiliary irises are not provided to divide microwave resonators in each case into a resonator space and a coupling space, but rather are developed so that the coupling of different modes may be influenced. In contrast to the design approach of the present invention, the apertures of the auxiliary irises there are arranged eccentrically with respect to the longitudinal axis of the resonator, and therefore with respect to the actual coupling iris.

Further advantages may be attained by the measures in the dependent claims.

According to claims 2 and 3, a plurality of resonators of the invention are suitable for implementing microwave filters. The coupling region can be doubled by the specific introduction of auxiliary irises into the resonators.

The measures of claims 4 and 5 make it possible to achieve a simple temperature-drift compensation, which according to the measures in claim 17, may also still be set or reset shortly prior to start-up or even during the operation of the microwave resonator or filter.

The effect of the measure in claim 6 is that very wide dimensioning limits may be selected for the coupling space, and therefore the influence of the coupling iris/es, i.e. field distortions, becomes minimal.

With the formation of the auxiliary iris/es according to claims 10 and 11, the effective length of a microwave resonator or a microwave filter may be shortened or lengthened.

By the selection of the form of the auxiliary iris according to claims 7, 8 or 9, the coupling effect may be planned in a targeted manner.

In particular, an effective coupling effect may be achieved for special operating modes.

According to claim 12, the measures of the present invention may also be used for co-axial waveguide couplings.

In addition, according to claim 13, the invention is suitable both for cylindrical and for rectangular microwave resonators/filters. According to claim 14, the coupled waveguides may also have a rectangular or cylindrical shape.

By the filling with dielectrics or dielectric inserts according to claim 15, the electrical properties may be selectively changed, also in combination with the positioning of the auxiliary iris/es and its/their form/s.

By the formation of the auxiliary iris/es and coupling iris/es according to claim 16, both types of iris are able to contribute to the coupling, and the electrical properties are favorably influenced.

With the measures according to claim 17, a drift compensation may be set or reset even after completion or already during operation of the microwave resonator/filter.

### BRIEF DESCRIPTION OF THE DRAWING

Exemplary embodiments are explained in greater detail with reference to the Drawing, in which:

FIG. 1 shows a microwave filter according to the related art;

FIG. 2 shows a microwave filter according to the related art having a deformed coupling iris;

FIG. 3 shows a microwave filter according to the present invention;

FIG. 4 shows a microwave filter having two auxiliary irises;

FIG. 5 shows a microwave filter with simple temperature-drift compensation;

FIG. 6 shows a slot-shaped auxiliary iris;

FIG. 7 shows an auxiliary iris having a circular aperture;

FIG. 8 shows a cross-shaped auxiliary iris;

FIG. 9 shows an auxiliary iris having a modified cross structure;

FIG. 10 shows a coupling of a resonator according to the present invention to a co-axial waveguide.

### DESCRIPTION OF EXEMPLARY EMBODIMENTS

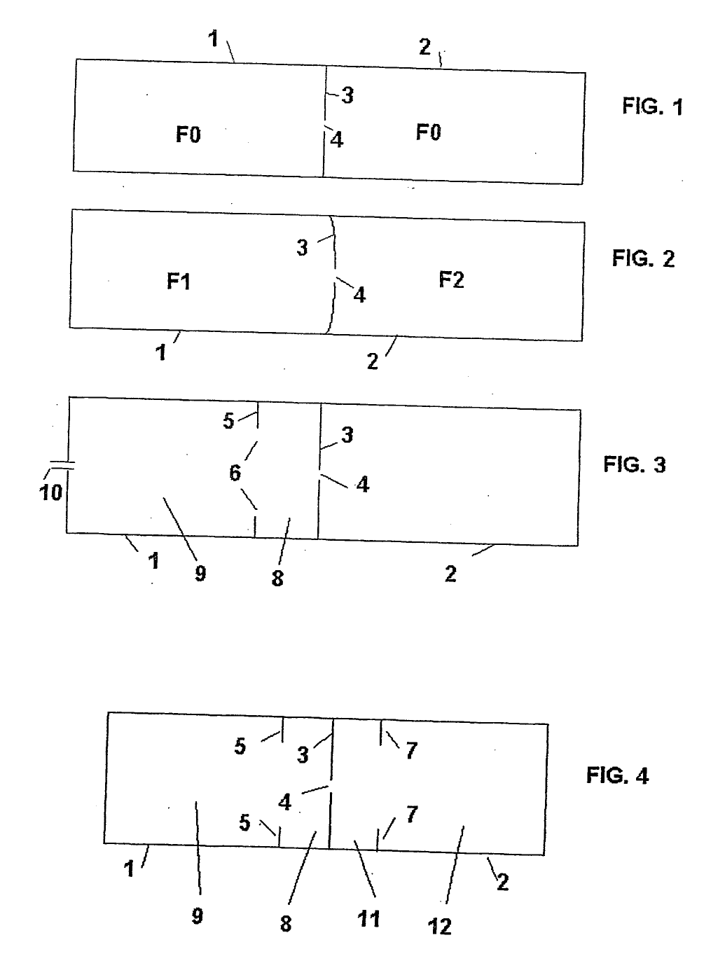

FIG. 1 shows the basic design of a customary microwave filter, made of two microwave resonators 1 and 2 which are in operative connection via a coupling iris 3 having iris aperture 4. Given equal geometric dimensions, microwave resonators 1 and 2 have the same resonant frequency F0. The operating modes of the microwave filter upstream and downstream of the microwave structure end at the surface of the shared iris and experience a field distortion through iris aperture 4 which is usually smaller relative to the iris size. Coupling iris 3 acts simultaneously on both adjoining resonators 1 and 2. If both resonators are equal, then the effect of coupling iris 3 on both modes is also equal. The frequency-dependent, complex impedance and the ohmic losses of the coupling iris, respectively, load the adjoining resonators. Various iris forms can have equal coupling effects, accompanied by different loading of the adjoining resonators. For the aforesaid reasons, the effort is to select coupling iris 3 to be relatively thin. However, this has the disadvantage that deformations of coupling iris 3 in the axial direction, which occur particularly in response to temperature change, lead to different resonant frequencies of adjoining resonators 1 and 2, or even to the excitation of unwanted vibrational modes. FIG. 2 shows a coupling iris 3 deformed by temperature changes. Resonant frequencies F1 and F2 of the resonators coupled to one another are different.

The design according to the invention of a microwave filter in FIG. 3 succeeds in minimizing the influence of coupling iris 3 on resonators 1 and 2. According to the invention, arranged upstream or downstream of a coupling iris 3, particularly in an axially symmetrical manner with respect to coupling iris 3, is an auxiliary iris 5 which has a larger iris aperture 6 than coupling iris 3. The effect of the larger iris aperture of auxiliary iris 5 is that the coupling is determined essentially by coupling iris 3. Auxiliary iris 5 alters the effective length of microwave resonator 1 and divides it into a resonator space 9, which extends from energy coupling 10 to auxiliary iris 5, and a coupling space 8 which extends from auxiliary iris 5 to coupling iris 3. If auxiliary iris 5 is arranged upstream of the coupling iris, the effective length of the microwave resonator in question, i.e. its resonant cavity, is shortened. If auxiliary iris 5 is arranged downstream of coupling iris 3, the effective length for those wave modes which are capable of propagating in this lengthened resonant cavity is extended.

Both coupling iris 3 and auxiliary iris 5 contribute to the total coupling of the two resonators. Preferably, auxiliary iris 5 is arranged at a distance of less than a quarter of the operating wavelength of resonator 1 upstream of coupling iris 3.

In a refinement of the invention, further resonator 2 may also be subdivided by an auxiliary iris 7 into a resonator space 12 and coupling space 11. If resonator 1 also has an auxiliary iris, the length of coupling space 8, 11 between the two resonant cavities 9, 12 doubles (FIG. 4).

The use of special forms for the auxiliary iris yields various possibilities for influencing the resonator in which the auxiliary iris is located, without or with only insignificant influencing of the coupling between the resonators. Thus, for example, a simple temperature-drift compensation is attainable with the aid of an auxiliary iris 5 that is deformable under temperature change, that is to say, the resonant frequency of the resonator or resonators remains equal to F0 (FIG. 5). To that end, for example, a bimetal auxiliary iris may be used. Since both the metal composition and its position in relation to coupling iris 3 play a role for the compensation, a greater degree of freedom is obtained for optimizing the compensation than, for example, with the cited U.S. Pat. No. 5,867,077. Thus, for example, a strictly contrary thermal characteristic of the resonator walls and the auxiliary irises is not necessary, since the position of auxiliary iris 5 within the resonator is still alterable, which may be utilized for the compensation. If auxiliary iris 5 or 7 is arranged in a manner that it is axially displaceable and able to be located in position in resonator 1 or 2, the compensation may be adjusted or altered afterwards, for example, shortly before or during the start-up.

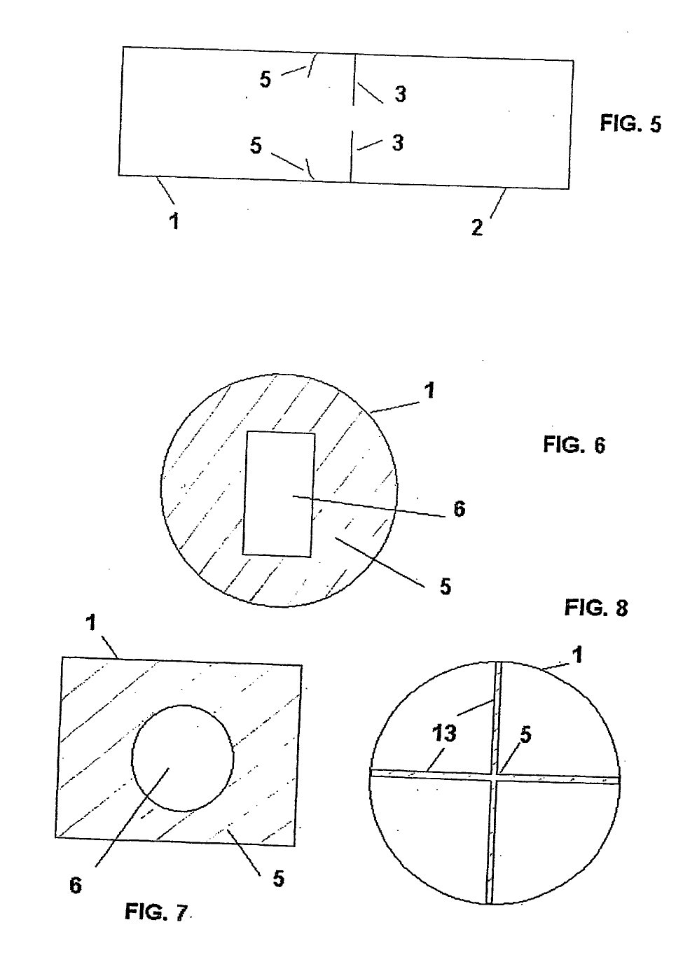

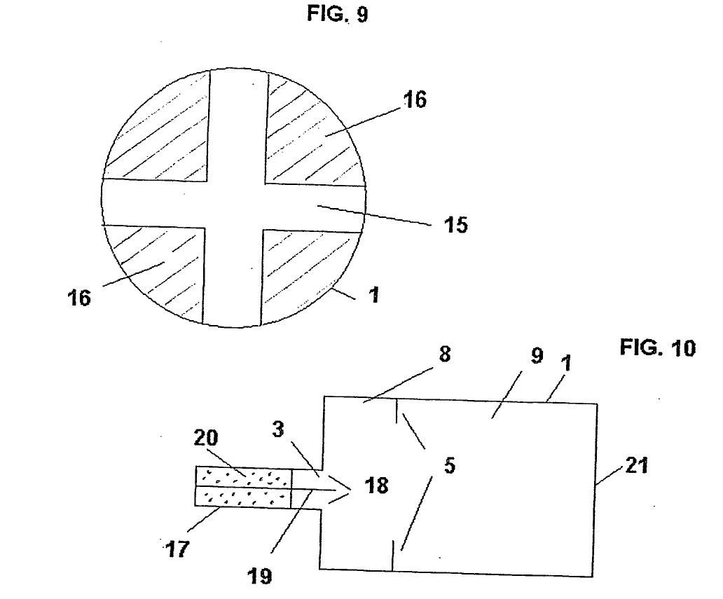

Depending on the operating modes used in the resonators, auxiliary irises 5 and 7, respectively, may be optimally selected, for instance, slot-shaped according to FIG. 6. There, a cylindrical resonator 1 is provided with an auxiliary iris having a rectangular slot 6. A rectangular resonator 1 may also be provided with an auxiliary iris 5 having a circular aperture 6 whose circle center is the axis of symmetry of the resonator or filter (FIG. 7). Naturally, combinations such as cylindrical resonator/circular auxiliary iris or rectangular resonator/slot-shaped iris are also possible. Auxiliary iris 5 may also be cross-shaped (FIG. 8). In this case, four open segments 14 are formed between bars 13 forming a cross. In the embodiment according to FIG. 9, cross structure 15 is open and four metallic segments 16 are formed. Further variants, particularly with a rectangular form of the resonators, are possible.

Of course, the microwave resonator or the microwave filter according to the present invention may be coupled to waveguides of the most varied kind, for example, to rectangular, circular or co-axial waveguides. FIG. 10 shows a coupling of a resonator 1 according to the invention to a co-axial waveguide 17. Here, coupling iris 3 is implemented by the junction from co-axial waveguide 17 to resonator 1. Iris aperture 18 is provided by the interior cross-section of the cladding of co-axial waveguide 17. Inner conductor 19 is laid bare from dielectric 20 in the area of the coupling and extends into resonator 1. According to the present invention, the field distortion caused by this coupling may likewise be reduced by auxiliary iris 5, since it again divides resonator 1 into a coupling space 8 and a resonator space 9. Coupling space 8 extends from the coupling of the co-axial waveguide/coupling iris 3 up to auxiliary iris 5, and resonator space 9 extends from auxiliary iris 5 up to resonator wall 21 facing away from the coupling.

Naturally, the resonator shown in FIG. 10 may be supplemented by a further resonator to form a microwave filter. Resonator 1 must then be lengthened accordingly, so that adjoining the resonator space may be a further auxiliary iris 5 and a corresponding coupling space, downstream of which is coupling iris 3 to further resonator 2.

Till now, the microwave filters were always shown as two-circuit filters. Naturally, a plurality of resonators having coupling irises and auxiliary irises may also be connected in series to implement multi-circuit filters.

In addition, the resonators may be completely or partially filled with dielectrics or dielectric inserts.

What is claimed is:

1. A microwave resonator having a coupling iris for coupling to a further microwave resonator or to a waveguide, comprising the following features:
an auxiliary iris (5) is provided which divides the microwave resonator (1, 2) into a resonator space (9) and a coupling space (8);
the auxiliary iris (5) has, in particular, a larger iris aperture (6) than the iris aperture (4) of the coupling iris (3), and is formed in such a way that it alters the length effective for the resonant frequency of the microwave resonator (1, 2);
the auxiliary iris (5) is arranged in an axially symmetric manner with respect to the coupling iris (3).

2. The microwave resonator as recited in claim 1,
wherein at least one further microwave resonator (2) is provided which, together with the microwave resonator (1), forms a microwave filter (1, 2).

3. The microwave filter as recited in claim 2,
wherein an auxiliary iris (7) is likewise provided in at least one further microwave resonator (2).

4. The microwave resonator or microwave filter as recited in one of claims 1 through 3,
wherein the auxiliary iris/es (5, 7) is/are constructed to be deformable in such a way that a temperature-drift compensation is attainable in response to temperature changes of the microwave resonator or filter.

5. The microwave resonator or microwave filter as recited in one of claims 1 through 4,
wherein the auxiliary irises or at least one auxiliary iris (5, 7) is made of bimetal.

6. The microwave resonator or microwave filter as recited in one of claims 1 through 3,
wherein the auxiliary iris/es (5, 7) is/are arranged at a distance of less than a quarter of the operating wavelength upstream or downstream of the coupling iris (3).

7. The microwave resonator or microwave filter as recited in one of claims 1 through 6,
wherein the auxiliary iris/es (5, 7) has/have a circular aperture (6) whose circle center is the axis of symmetry of the microwave resonator or filter (1, 2).

8. The microwave resonator or microwave filter as recited in one of claims 1 through 6,
wherein the auxiliary iris (5, 7) is slot-shaped.

9. The microwave resonator or microwave filter as recited in one of claims 1 through 6,
wherein the auxiliary iris (5, 7) is cross-shaped.

10. The microwave resonator or microwave filter as recited in one of claims 1 through 9,
wherein the auxiliary iris/es (5, 7) is/are constructed in such a way that it/they shortens/shorten the effective length of the microwave resonator/s.

11. The microwave resonator or microwave filter as recited in one of claims 1 through 9,
wherein the auxiliary iris/es (5, 7) is/are constructed in such a way that it/they extends/extend the effective length of the microwave resonator/s (1, 2).

12. The microwave resonator or microwave filter as recited in one of claims 1 through 11,
wherein an energy coupling into the microwave resonator/s (1, 2) is provided via a co-axial waveguide (17), the coupling iris (3) being implemented by the junction from the co-axial waveguide (17) to the resonator (1).

13. The microwave resonator or microwave filter as recited in one of claims 1 through 12,
characterized by a cylindrical or rectangular formation of the resonance space/s (9, 12) and/or coupling space/s (8, 11).

14. The microwave resonator or microwave filter as recited in one of claims 1 through 13,
characterized by a coupled waveguide in rectangular or cylindrical form.

15. The microwave resonator or microwave filter as recited in one of claims 1 through 14,
wherein the resonance space/s (9, 12) of the microwave resonator (1) or of the further microwave resonators (2) is/are filled with a dielectric or has/have a dielectric insert.

16. The microwave resonator or microwave filter as recited in one of claims 1 through 15,
wherein the coupling iris/es as well as the auxiliary iris/es are constructed in such a way that both contribute to the coupling.

17. The microwave resonator or microwave filter as recited in one of claims 1 through 16,
wherein the auxiliary iris/es (5, 7) is/are arranged in a manner that it/they is/are axially displaceable and able to be located in position in the microwave resonator (1), or in the further microwave resonator/s (2).
